(19) United States
(12) Patent Application Publication
(10) Pub. No.: US 2023/0250849 A1
(43) Pub. Date: Aug. 10, 2023

(54) GUIDE DEVICE

(71) Applicant: Komatsu Ltd., Tokyo (JP)

(72) Inventor: Kenichi Tomita, Tokyo (JP)

(73) Assignee: Komatsu Ltd., Tokyo (JP)

(21) Appl. No.: 18/012,241

(22) PCT Filed: Jun. 4, 2021
(86) PCT No.: PCT/JP2021/021394

§ 371 Date: Dec. 22, 2022

(30) Foreign Application Priority Data
Jul. 31, 2020 (JP) 2020-129899

(51) Int. Cl. F16C 32/06; F16C 29/02; B23Q 1/42; B23Q 11/12

(52) U.S. Cl. CPC F16C 32/06; F16C 29/02; B23Q 1/42; B23Q 11/124

(57) ABSTRACT

A guide device includes a support that includes a guide surface, and a movable body that includes an oil pocket to which lubricant is supplied and a sliding surface facing the guide surface. The sliding surface includes a first region that is arranged around the oil pocket and formed of a first material, and a second region that is arranged at least partially around the first region and formed of a second material.

### FIELD

The present disclosure relates to a guide device.

### BACKGROUND

In the technical field related to guide devices, a guide device as disclosed in Patent Literature 1 is known. The guide device includes a support that includes a guide surface and a movable body that includes a sliding surface.

### CITATION LIST

### Patent Literature

Patent Literature 1: JP 2005-313272 A

### SUMMARY

### Technical Problem

For the guide device, it is required to reduce friction between the guide surface of the support and the sliding surface of the movable body.

### Solution to Problem

According to an aspect of the present invention, a guide device comprises: a support that includes a guide surface; and a movable body that includes an oil pocket to which lubricant is supplied and a sliding surface facing the guide surface, wherein the sliding surface includes: a first region that is arranged around the oil pocket and formed of a first material; and a second region that is arranged at least partially around the first region and formed of a second material.

### Advantageous Effects of Invention

According to the present disclosure, friction between the guide surface of the support and the sliding surface of the movable body is reduced.

### BRIEF DESCRIPTION OF DRAWINGS

FIG. 1 is a diagram schematically illustrating a machine tool according to a first embodiment.

FIG. 2 is a cross-sectional view schematically illustrating a guide device according to the first embodiment.

FIG. 3 is a bottom view of a movable body according to the first embodiment.

FIG. 4 is a graph illustrating results of an evaluation test for sliding materials according to the first embodiment.

FIG. 5 is an exploded view schematically illustrating the movable body according to the first embodiment.

FIG. 6 is a plan view illustrating the movable body according to the first embodiment.

FIG. 7 is a plan view illustrating a movable body according to a second embodiment.

FIG. 8 is a plan view illustrating a movable body according to a third embodiment.

FIG. 9 is a plan view illustrating a movable body according to a fourth embodiment.

FIG. 10 is a cross-sectional view schematically illustrating a guide device according to a fifth embodiment.

### DESCRIPTION OF EMBODIMENTS

Embodiments of the present disclosure will be described below with reference to the drawings, but the present disclosure is not limited to the embodiments.

Component elements according to the embodiments described below may be appropriately combined with each other. Furthermore, in some cases, some of the component elements may not be used.

In the following description, a three-dimensional orthogonal coordinate system is set to a guide device, and positional relationships between the portions of the guide device will be described with reference to the three-dimensional orthogonal coordinate system. A direction parallel to an X-axis in a predetermined plane is an X-axis direction. A direction parallel to a Y-axis orthogonal to the X-axis in the predetermined plane is defined as a Y-axis direction. A direction parallel to a Z-axis orthogonal to each of the X-axis and the Y-axis is defined as a Z-axis direction. A rotation or tilting direction about the X-axis is defined as an A axis direction. A rotation or tilting direction about the Z-axis is defined as a C axis direction. A plane including the X-axis and the Y-axis is defined as an XY plane. A plane including the Y-axis and the Z-axis is defined as a YZ plane. A plane including the Z-axis and the X-axis is defined as a ZX plane. The predetermined plane described above is the XY plane. The X-axis is orthogonal to the YZ plane. The

Y-axis is orthogonal to the ZX plane. The Z-axis is orthogonal to the XY plane. In the embodiment, the Y-axis direction is a vertical direction. The ZX plane is parallel to a horizontal plane.

### First Embodiment

A first embodiment will be described.

### <Machine Tool>

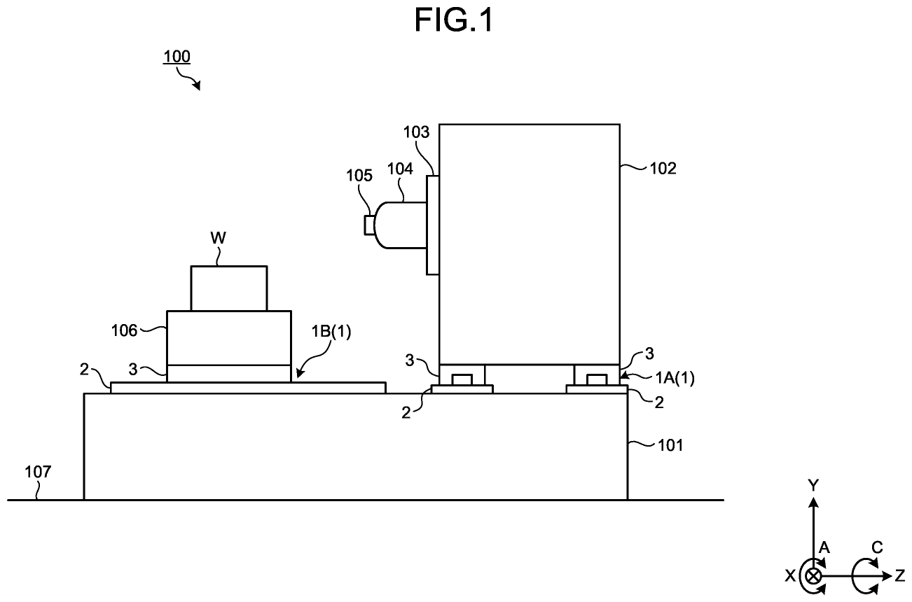

FIG. 1 is a diagram schematically illustrating a machine tool 100 according to the present embodiment. In the present embodiment, the machine tool 100 is a machining center.

The machine tool 100 includes a bed 101, a column 102, a first support member 103, a second support member 104, a head 105, and a table 106.

The bed 101 is fixed to a support surface 107. As the support surface 107, a floor surface of a factory on which the machine tool 100 is installed is exemplified.

The column 102 is movably supported on the bed 101 via a guide device 1A. The guide device 1A guides the column 102 in the X-axis direction. The column 102 moves in the X-axis direction while being guided by the guide device 1A.

The first support member 103 is movably supported by the column 102. The first support member 103 moves in the Y-axis direction.

The second support member 104 is movably supported by the first support member 103. The second support member 104 rotates in the C axis directions.

The head 105 holds a tool. The head 105 is movably supported by the second support member 104. The head 105 rotates in the A axis directions.

The table 106 supports a work W. The table 106 is movably supported on the bed 101 via a guide device 1B.

The guide device 1B guides the table 106 in the Z-axis directions. The table 106 moves in the Z-axis directions while being guided by the guide device 1B.

### <Guide Device>

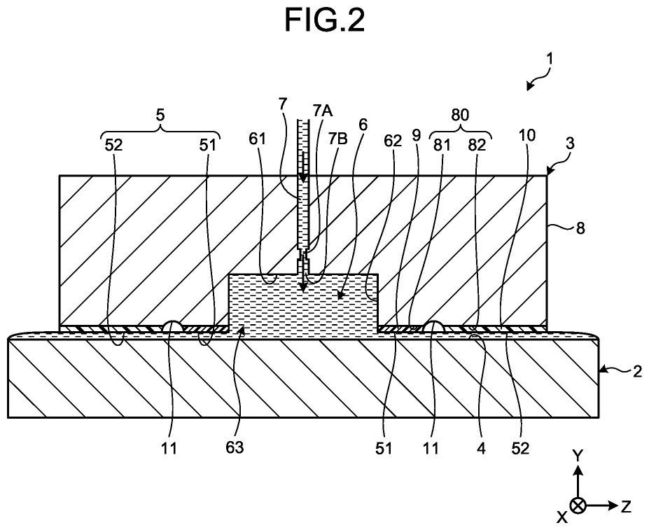

FIG. 2 is a cross-sectional view schematically illustrating a guide device 1 according to the present embodiment. The guide device 1 is used as at least one of the guide device 1A and the guide device 1B which have been described with reference to FIG. 1. In the following description, it is assumed that the guide device 1 is used as the guide device 1A. The guide device 1 is arranged between the bed 101 and the column 102. The guide device 1 guides the column 102 in the X-axis directions.

As illustrated in FIGS. 1 and 2, the guide device 1 includes a support 2 and a movable body 3. The support 2 is fixed to an upper surface of the bed 101. The support 2 extends in the X-axis direction. The movable body 3 is fixed to a lower surface of the column 102. The movable body 3 is movable relative to the support 2. The movable body 3 is guided to move in the X-axis directions relative to the support 2.

The support 2 includes a guide surface 4. The guide surface 4 includes an upper surface of the support 2.

The guide surface 4 is a flat surface. The guide surface 4 is parallel to the ZX plane. The guide surface 4 extends in the X-axis direction.

The guide surface 4 is formed of a metal material. In the present embodiment, the support 2 is made of steel. The guide surface 4 is formed of a steel material.

### <Movable Body>

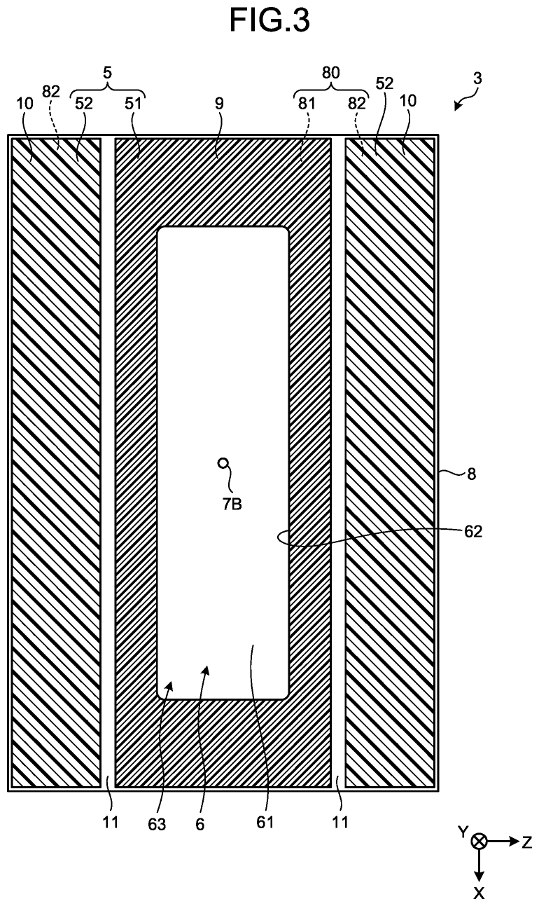

FIG. 3 is a bottom view of the movable body 3 according to the present embodiment. As illustrated in

FIGS. 2 and 3, the movable body 3 includes a sliding surface 5. The sliding surface 5 includes a lower surface of the movable body 3. The sliding surface 5 has substantially a flat surface. The sliding surface 5 may include minute irregularities. The sliding surface 5 is parallel to the ZX plane. The sliding surface 5 faces the guide surface 4. The sliding surface 5 moves in the X-axis directions while facing the guide surface 4. The sliding surface 5 moves in the X-axis directions while making contact with the guide surface 4. Note that in FIG. 2, the guide surface 4 and the sliding surface 5 are illustrated to be separated from each other for easy viewing.

The sliding surface 5 is formed of a synthetic resin material.

The movable body 3 includes an oil pocket 6. The oil pocket 6 is a recess provided in part of the sliding surface 5. The oil pocket 6 is formed so as to be recessed upward from the sliding surface 5. Lubricant is supplied to the oil pocket 6.

The oil pocket 6 includes a ceiling surface 61, peripheral wall surfaces 62, and an opening 63. The ceiling surface 61 is arranged above the sliding surface 5. The ceiling surface 61 is directed downward. The ceiling surface 61 is parallel to the ZX plane. The peripheral wall surfaces 62 are connected to peripheral edges of the ceiling surface 61. The peripheral wall surfaces 62 are orthogonal to the ZX plane. Some of the peripheral wall surfaces 62 are parallel to the XY plane. Some of the peripheral wall surfaces 62 are parallel to the YZ plane. The opening 63 is arranged at lower ends of the peripheral wall surfaces 62. The opening 63 faces the guide surface 4. Note that the ceiling surface 61 may be inclined relative to the ZX plane or may include a curved surface.

The peripheral wall surfaces 62 may not be orthogonal to the ZX plane or may include a curved surface.

In the ZX plane, the oil pocket 6 has a rectangular shape elongated in the X-axis direction. A dimension of the opening 63 in the X-axis direction is larger than a dimension of the opening 63 in the Z-axis direction.

The movable body 3 includes an oil passage 7. The lubricant is supplied to the oil pocket 6 through the oil passage 7. The oil passage 7 includes a throttle 7A and a supply port 7B. The throttle 7A adjusts a flow rate of the lubricant supplied to the oil pocket 6. The supply port 7B supplies the lubricant whose flow rate has been adjusted to the oil pocket 6. The supply port 7B is provided in the ceiling surface 61 of the oil pocket 6. In the present embodiment, the supply port 7B is provided at the center of the ceiling surface 61.

The oil pocket 6 is filled with the lubricant supplied from the supply port 7B. At least part of the lubricant supplied from the supply port 7B to the oil pocket 6 is supplied between the guide surface 4 and the sliding surface 5 through the opening 63. The lubricant having the adjusted flow rate and supplied between the guide surface 4 and the sliding surface 5 causes the movable body 3 to slightly float relative to the support 2. The lubricant having the adjusted flow rate and supplied between the guide surface 4 and the sliding surface 5 reduces friction between the guide surface 4 and the sliding surface 5 is reduced.

The movable body 3 includes a base member 8, a first film 9, and a second film 10.

The base member 8 is made of a metal. In the present embodiment, the base member 8 is made of steel.

The oil pocket 6 is provided in part of a lower surface 80 of the base member 8. In the present embodiment, the oil pocket 6 is provided at the center of the lower surface 80 of the base member 8. The oil pocket 6 is formed so as to be recessed upward from the lower surface 80.

The first film 9 are arranged on at least part of the lower surface 80 of the base member 8. The first film 9 is arranged in an annular area 81 of the lower surface 80 around the opening 63.

The second film 10 is arranged at least partially around the first film 9 on the lower surface 80 of the base member 8. The second film 10 is arranged in an outer area 82 of the lower surface 80, outside from the annular area 81. In the present embodiment, the first film 9 and the second film 10 are arranged in the Z-axis direction. The second film 10 is arranged on each of a +Z side and a −Z side of the first film 9.

The first film 9 is formed of a first material. The second film 10 is formed of a second material. Each of the first material and the second material is a synthetic resin material. A physical characteristic of the first material is different from a physical characteristic of the second material.

The sliding surface 5 of the movable body 3 includes a first region 51 that is arranged around the oil pocket 6 and a second region 52 that is arranged at least partially around the first region 51. The first region 51 includes a lower surface of the first film 9. The second region 52 includes a lower surface of the second film 10. The first region 51 is formed of the first material. The second region 52 is formed of the second material. Each of the first material and the second material is a sliding material that forms the sliding surface 5.

A coefficient of friction of the second region 52 to the guide surface 4 is lower than a coefficient of friction of the first region 51 to the guide surface 4.

In the present embodiment, the first material is the synthetic resin material containing an epoxy resin as a main component. The second material is the synthetic resin material containing polytetrafluoroethylene (PTFE) as a main component. As the first material, Moglice (trade name) is exemplified. As the second material, Turcite (registered trademark) or Bearee (registered trademark) is exemplified.

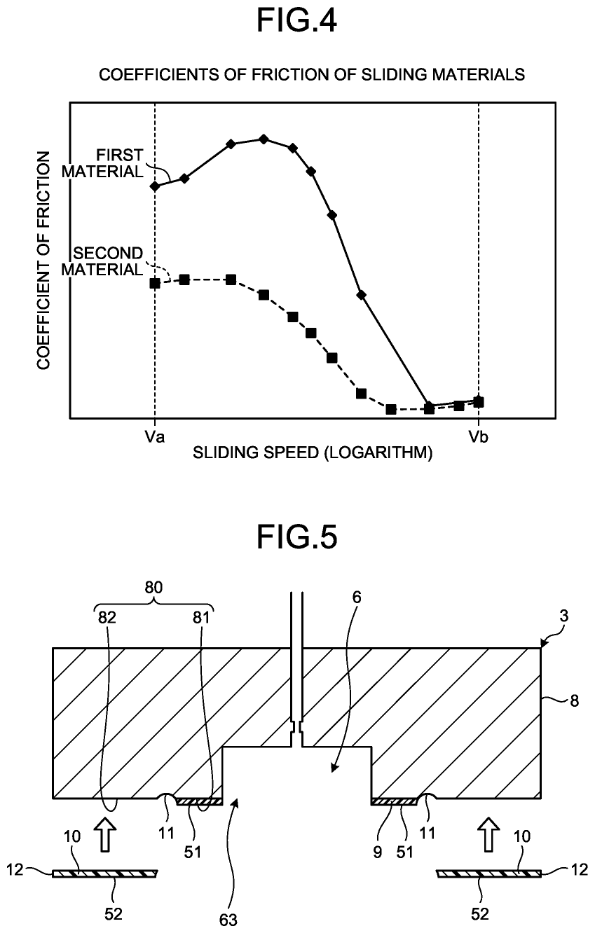

FIG. 4 is a graph illustrating results of an evaluation test for sliding materials according to the present embodiment. FIG. 4 is a graph showing a relationship between sliding speed and the coefficient of friction when the sliding surface 5 is slid relative to the guide surface 4 under a general use condition of the machine tool 100. The sliding speed is a moving speed of each sliding material relative to the guide surface 4. The coefficient of friction is a coefficient of friction of each sliding material to the guide surface 4. In the graph illustrated in FIG. 4, the horizontal axis represents the 10 sliding speed logarithmically represented and the vertical axis represents the coefficient of friction. As the sliding materials, the first material and the second material were evaluated.

In the evaluation test, the coefficient of friction of the first material and the coefficient of friction of the second material were measured in a range from a first sliding speed Va to a second sliding speed Vb that is higher than the first sliding speed Va. As shown in FIG. 4, in the range from the first sliding speed Va to the second sliding speed Vb, the coefficient of friction of the second material (second region 52) to the guide surface 4 is lower than the coefficient of friction of the first material (first region 51) to the guide surface 4.

As illustrated in FIGS. 2 and 3, the first region 51 is directed downward so as to face the guide surface 4.

The first region 51 is substantially parallel to the ZX plane. The first region 51 is arranged so as to surround the opening 63 of the oil pocket 6. The first region 51 has a rectangular outer shape elongated in the X-axis direction.

The second region 52 is directed downward so as to face the guide surface 4. The second region 52 is substantially parallel to the ZX plane. The second region 52 is arranged partially around the first region 51. The second region 52 has a rectangular outer shape elongated in the X-axis direction.

The first region 51 and the second region 52 are arranged in the same plane. In other words, the height of the first region 51 is equal to the height of the second region 52. The height represents a position in the Y-axis direction.

The first region 51 and the second region 52 are arranged in the Z-axis direction orthogonal to the X-axis direction. Two second regions 52 are arranged on the lower surface 80. The second regions 52 are arranged on a +Z side and a −Z side of the first region 51. The outer shapes and dimensions of the two second regions 52 are equal to each other.

In the X-axis direction, the dimension of the first region 51 is equal to the dimension of the second region 52. In the X-axis direction, the position of an end of the first region 51 is equal to the position of an end of the second region 52. In the Z-axis direction, the dimension of the first region 51 is larger than the dimension of each second region 52.

On the sliding surface 5, a proportion of the second region 52 is larger than a proportion of the first region 51. In other words, the area of the second region 52 is larger than the area of the first region 51. In the present embodiment, the area of the second region 52 means a sum of the areas of the two second regions 52.

In the ZX plane, a distance between the oil pocket 6 and the second region 52 is larger than a distance between the oil pocket 6 and the first region 51. The distance between the oil pocket 6 and the second region 52 represents the shortest distance between the peripheral edge of the opening 63 and the second region 52. The distance between the oil pocket 6 and the first region 51 represents the shortest distance between the peripheral edge of the opening 63 and the first region 51. Note that the distance between the oil pocket 6 and the second region 52 may be the shortest distance from the center of the oil pocket 6 to the second region 52. The distance between the oil pocket 6 and the first region 51 may be the shortest distance from the center of the oil pocket 6 to the first region 51.

In other words, the second region 52 is arranged at a position farther from the oil pocket 6 than the first region 51. The second region 52 is arranged at a position farther from the oil pocket 6 than the first region 51, and thus, a static pressure of the lubricant acting on the second region 52 is lower than a static pressure of the lubricant acting on the first region 51.

The movable body 3 includes a groove 11 that is provided between the first region 51 and the second region 52. The groove 11 is provided in the lower surface 80 of the base member 8. The groove 11 is formed so as to be recessed upward from the lower surface 80. The groove 11 is provided so as to separate the first film 9 from the second film 10. The first film 9 and the second film 10 are not arranged inside the groove 11.

The groove 11 is formed so as to be connected to peripheral edges of the sliding surface 5. As illustrated in FIG. 3, the groove 11 extends in the X-axis direction between the first region 51 and the second region 52. The groove 11 has an end on a +X side that is connected to a peripheral edge on the +X side of the sliding surface 5. The groove 11 has an end on a −X side that is connected to a peripheral edge on the −X-side of the sliding surface 5.

The ambient air around the sliding surface 5 is allowed to flow into the groove 11 through the ends of the groove 11. Air inside the groove 11 is allowed to flow out to the external space around the sliding surface 5 through the ends of the groove 11. The groove 11 is open to atmosphere.

At least part of the lubricant supplied from the supply port 7B to the oil pocket 6 is supplied between the guide surface 4 and the first region 51 through the opening 63. At least part of the lubricant supplied between the guide surface 4 and the first region 51 is supplied between the guide surface 4 and the second region 52. The groove 11 is provided between the first region 51 and the second region 52, and thus, the static pressure of the lubricant acting on the second region 52 is lower than the static pressure of the lubricant acting on the first region 51.

### <Method of Manufacturing Movable Body>

FIG. 5 is an exploded view schematically illustrating the movable body 3 according to the present embodiment. In the present embodiment, the first film 9 is formed of the first material applied to the base member 8. The first material is applied to the annular area 81 surrounding the opening 63 of the oil pocket 6. The first material is a so-called sliding material for coating. The first material is liquid. The first material is, for example, a mixture of a base resin and a curing agent. After the first material being liquid is applied to the annular area 81 of the base member 8, for example, the base resin and the curing agent react with each other for curing, and thus, the first film 9 is arranged in the annular area 81 of the base member 8. The first film 9 is fixed to the annular area 81. The lower surface of the first film 9 forms the first region 51.

In the present embodiment, the second film 10 is a sheet material 12 of the second material bonded to the base member 8. The sheet material 12 of the second material is bonded to each of the outer areas 82 outside the annular area 81 with an adhesive. The second material is a so-called adhesive sliding material. The sheet material 12 of the second material is bonded to the outer area 82 with the adhesive, and thus, the second film 10 is arranged in the outer area 82 of the base member 8. The second film 10 is fixed to the outer area 82. The lower surface of the second film 10 forms the second region 52.

### <Specific Example of Movable Body>

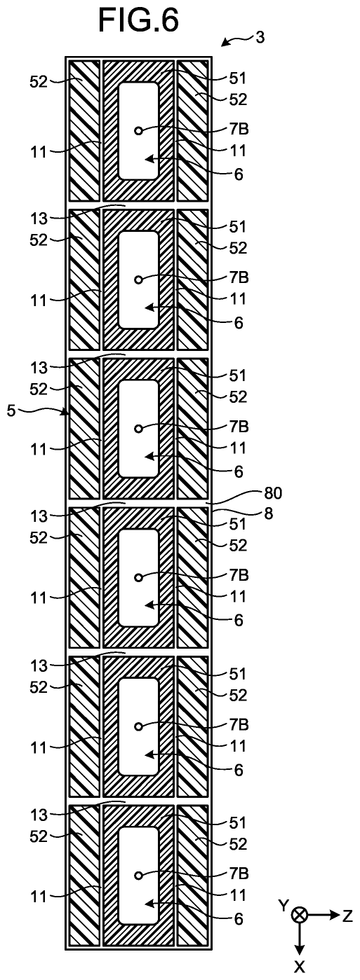

FIG. 6 is a plan view illustrating the movable body 3 according to the present embodiment. In FIG. 6, the movable body 3 is guided to move in the X-axis directions relative to the support 2.

As illustrated in FIG. 6, the movable body 3 is elongated in the X-axis direction. A dimension of the movable body 3 in the X-axis direction is larger than a dimension of the movable body 3 in the Z-axis direction.

The lower surface 80 of the base member 8 has a rectangular outer shape elongated in the X-axis direction. A plurality of the oil pockets 6 is provided on the lower surface 80 of the base member 8. The oil pockets 6 are arranged at intervals in the X-axis direction. One oil pocket 6 is arranged in the Z-axis direction. In the X-axis direction, the intervals between the plurality of the oil pockets 6 may be equal or unequal. In the Z-axis direction, the center of the oil pocket 6 and the center of the base member 8 coincide with each other. In the ZX plane, the oil pocket 6 has a rectangular shape elongated in the X-axis direction. The plurality of oil pockets 6 have equal shapes and dimensions.

The first region 51 is arranged so as to surround each of the plurality of the oil pockets 6. The first region 51 has a rectangular outer shape elongated in the X-axis direction. The outer shapes and dimensions of a plurality of the first regions 51 are equal to each other.

The second regions 52 are arranged at intervals in the X-axis direction. Two second regions 52 are arranged at an interval in the Z-axis direction. The first region 51 and the second regions 52 are arranged in the Z-axis direction. The first region 51 and the second regions 52 are alternately arranged in the Z-axis direction. One second region 52 is arranged on each of the +Z side and the −Z side of the first region 51. The second region 52 has a rectangular outer shape elongated in the X-axis direction. The outer shapes and dimensions of the plurality of the second regions 52 are equal to each other.

In the X-axis direction, a dimension of the outer shape of the first region 51 is equal to a dimension of the outer shape of the second region 52. In the Z-axis direction, a dimension of the outer shape of the first region 51 is larger than a dimension of the outer shape of the second region 52.

The groove 11 is provided between the first region 51 and each second region 52. The groove 11 extends in the X-axis direction.

Grooves 13 are provided between the first regions 51 adjacent in the X-axis direction and between the second regions 52 adjacent in the X-axis direction. Each of the groove 13 is formed so as to be recessed upward from the lower surface 80. The groove 13 extends in the Z-axis direction. The groove 13 is connected to the peripheral edges of the sliding surface 5. The groove 13 has an end on a +Z side that is connected to a peripheral edge on a +Z side of the sliding surface 5. The groove 13 has an end on a −Z side that is connected to a peripheral edge on a −Z side of the sliding surface 5. The groove 13 is open to atmosphere. Each groove 11 is connected to the groove 13. The groove 11 is open to atmosphere through the groove 13.

When the movable body 3 moves relative to the support 2, a dynamic pressure of the lubricant acts on the sliding surface 5. The groove 13 reduces the dynamic pressure acting on the sliding surface 5.

### Effects

As described above, according to the present embodiment, the sliding surface 5 includes the first region 51 that is arranged around the oil pocket 6 and the second region 52 that is arranged at least partially around the first region 51. The first region 51 is formed of the first material. The second region 52 is formed of the second material different from the first material. Appropriate selection of each of the first material and the second material reduces the friction between the guide surface 4 of the support 2 and the sliding surface 5 of the movable body 3. In addition, appropriate selection of each of the first material and the second material suppresses a decrease in reliability of the guide device 1.

In the present embodiment, the first region 51 is annularly arranged around the opening 63 of the oil pocket 6. The second region 52 is arranged at least partially around the first region 51. In the ZX plane, the distance between the oil pocket 6 and the second region 52 is larger than the distance between the oil pocket 6 and the first region 51. Therefore, the static pressure acting on the second region 52 becomes lower than the static pressure acting on the first region 51. The reduced static pressure acting on the second region 52 suppresses deterioration of the second region 52. Therefore, a reduction in the reliability of the guide device 1 is suppressed.

The first film 9 is formed by curing the first material being liquid that has been applied to the annular area 81 on the lower surface 80 of the base member 8.

Thus, the first film 9 is firmly fixed to the annular area 81 of the base member 8. The second film 10 is formed by bonding the sheet material 12 of the second material to the outer area 82 on the lower surface 80 of the base member 8. Therefore, the second film 10 is fixed to the base member 8 with good workability. In the present embodiment, a static pressure acting on the second film 10 is lower than a static pressure acting on the first film 9. Therefore, peeling of the second film 10 from the base member 8 is suppressed. The first film 9 is firmly fixed to the base member 8. Therefore, even if the static pressure acting on the first film 9 is higher than the static pressure acting on the second film 10, the possibility of peeling of the first film 9 from the base member 8 is low. Accordingly, a reduction in the reliability of the guide device 1 is suppressed.

The first material forming the first film 9 is the synthetic resin material containing an epoxy resin as the main component. Therefore, the first film 9 is firmly fixed to the base member 8. The second material forming the second film 10 is the synthetic resin material containing polytetrafluoroethylene as the main component. A coefficient of friction of the second film 10 to the guide surface 4 is lower than a coefficient of friction of the first film 9 to the guide surface 4. Therefore, the friction between the guide surface 4 of the support 2 and the sliding surface 5 of the movable body 3 is reduced.

The area of the second region 52 is larger than the area of the first region 51. Therefore, the friction between the guide surface 4 of the support 2 and the sliding surface 5 of the movable body 3 is reduced.

At least part of the lubricant supplied from the supply port 7B to the oil pocket 6 is supplied between the first region 51 and the guide surface 4 through the opening 63. At least part of the lubricant supplied between the first region 51 and the guide surface 4 is supplied between the second region 52 and the guide surface 4. The groove 11 is provided between the first region 51 and the second region 52, and thus, the static pressure acting on the second region 52 is lower than the static pressure acting on the first region 51.

The groove 11 is formed so as to be connected to peripheral edges of the sliding surface 5. Therefore, the groove 11 is open to atmosphere. Therefore, the static pressure acting on the second region 52 becomes sufficiently low.

### Second Embodiment

A second embodiment will be described. In the following description, component elements the same as or equivalent to those in the above embodiment are denoted by the same reference numerals and symbols, and description thereof will be simplified or omitted.

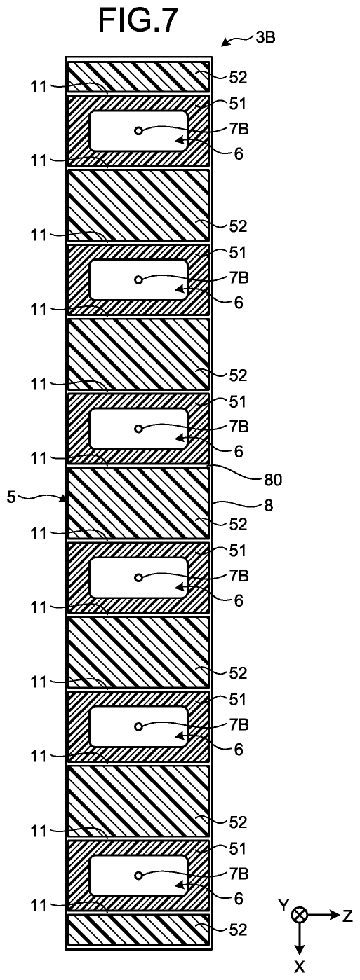

FIG. 7 is a plan view illustrating a movable body 3B according to the present embodiment. The movable body 3B is guided to move in the X-axis directions relative to the support 2.

As illustrated in FIG. 7, the movable body 3B is long in the X-axis direction. The oil pockets 6 are arranged at intervals in the X-axis direction. One oil pocket 6 is arranged in the Z-axis direction. In the Z-axis direction, the center of the oil pocket 6 and the center of the base member 8 coincide with each other. In the ZX plane, the oil pocket 6 has a rectangular shape elongated in the Z-axis direction. The plurality of oil pockets 6 have equal shapes and dimensions.

The first region 51 is arranged so as to surround each of the plurality of the oil pockets 6. The first region 51 has a rectangular outer shape elongated in the Z-axis direction. The outer shapes and dimensions of the plurality of the first regions 51 are equal to each other.

The second regions 52 are arranged at intervals in the X-axis direction. One second region 52 is arranged in the Z-axis direction. The first region 51 and the second region 52 are arranged in the X-axis direction. The first region 51 and the second region 52 are alternately arranged in the X-axis direction. The second region 52 is arranged between the first regions 51 adjacent to each other in the X-axis direction. The second region 52 has a rectangular outer shape elongated in the Z-axis direction. The outer shapes and dimensions of two second regions 52 arranged at ends in the X-axis direction are equal to each other. The outer shapes and dimensions of five second regions 52 arranged in the intermediate portion in the X-axis direction are equal to each other.

In the X-axis direction, a dimension of the outer shape of each first region 51 is equal to a dimension of the outer shape of each second region 52 in the intermediate portion. In the Z-axis direction, a dimension of the outer shape of each first region 51 is equal to a dimension of the outer shape of each second region 52.

The groove 11 is provided between the first region 51 and each second region 52. Each of the grooves 11 extends in the Z-axis direction. The groove 11 is connected to the peripheral edges of the sliding surface 5. The groove 11 has an end on a +Z side that is connected to a peripheral edge on the +Z side of the sliding surface 5. The groove 11 has an end on a −Z side that is connected to a peripheral edge on the −Z side of the sliding surface 5. The groove 11 is open to atmosphere.

The groove 11 reduces the static pressure acting on the second region 52. The groove 11 also reduces the dynamic pressure acting on the sliding surface 5.

As described above, in the present embodiment as well, friction between the guide surface 4 of the support 2 and the sliding surface 5 of the movable body 3B is reduced. In addition, a decrease in the reliability of the guide device 1 is suppressed.

### Third Embodiment

A third embodiment will be described. In the following description, component elements the same as or equivalent to those in the above embodiment are denoted by the same reference numerals and symbols, and description thereof will be simplified or omitted.

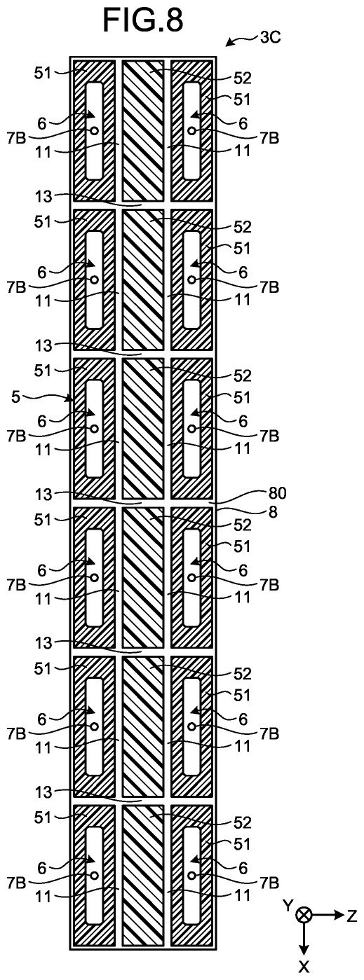

FIG. 8 is a plan view illustrating a movable body 3C according to the present embodiment. In FIG. 8, the movable body 3C is guided to move in the X-axis directions relative to the support 2.

As illustrated in FIG. 8, the movable body 3C is elongated in the X-axis direction. Six oil pockets 6 are arranged at intervals in the X-axis direction. Two oil pockets 6 are arranged at an interval in the Z-axis direction. In the ZX plane, the oil pocket 6 has a rectangular shape elongated in the X-axis direction. The plurality of oil pockets 6 have equal shapes and dimensions.

The first region 51 is arranged so as to surround each of the plurality of the oil pockets 6. The first region 51 has a rectangular outer shape elongated in the X-axis direction. The outer shapes and dimensions of the plurality of the first regions 51 are equal to each other.

The second regions 52 are arranged at intervals in the X-axis direction. One second region 52 is arranged in the Z-axis direction. The first regions 51 and the second region 52 are arranged in the Z-axis direction. The first regions 51 and the second region 52 are alternately arranged in the Z-axis direction. The second region 52 is arranged between the first regions 51 adjacent to each other in the Z-axis direction. In the Z-axis direction, the center of the second region 52 and the center of the base member 8 coincide with each other. The second region 52 has a rectangular outer shape elongated in the X-axis direction. The outer shapes and dimensions of the plurality of the second regions 52 are equal to each other.

In the X-axis direction, a dimension of the outer shape of the first region 51 is equal to a dimension of the outer shape of the second region 52. In the Z-axis direction, a dimension of the outer shape of each first region 51 is equal to a dimension of the outer shape of each second region 52.

The groove 11 is provided between the first region 51 and each second region 52. The groove 11 extends in the X-axis direction.

Grooves 13 are provided between the first regions 51 adjacent in the X-axis direction and between the second regions 52 adjacent in the X-axis direction. The groove 13 extends in the Z-axis direction. The groove 13 is open to atmosphere. Each groove 11 is connected to the groove 13. The groove 11 is open to atmosphere through the groove 13.

The groove 11 reduces the static pressure acting on the second region 52. The groove 13 reduces the dynamic pressure acting on the sliding surface 5.

As described above, in the present embodiment as well, friction between the guide surface 4 of the support 2 and the sliding surface 5 of the movable body 3C is reduced. In addition, a decrease in the reliability of the guide device 1 is suppressed.

### Fourth Embodiment

A fourth embodiment will be described. In the following description, component elements the same as or equivalent to those in the above embodiment are denoted by the same reference numerals and symbols, and description thereof will be simplified or omitted.

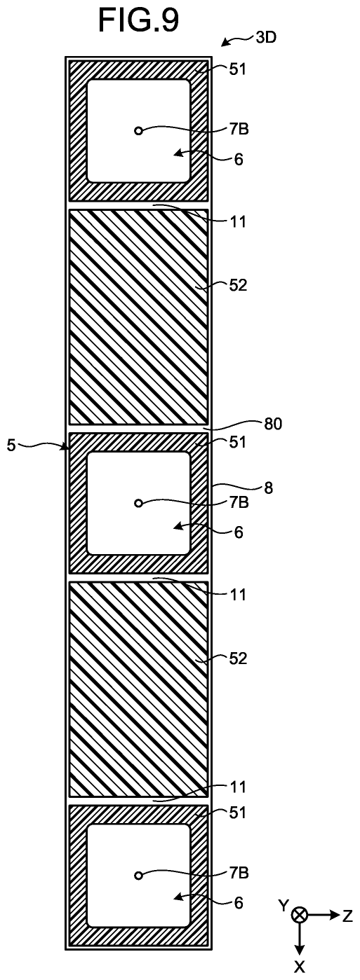

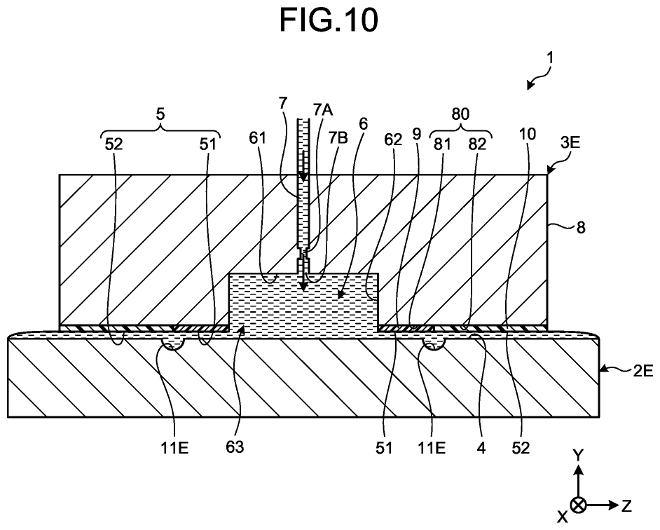

FIG. 9 is a plan view illustrating a movable body 3D according to the present embodiment. The movable body 3D is guided to move in the X-axis directions relative to the support 2.

As illustrated in FIG. 9, the movable body 3D is elongated in the X-axis direction. The oil pockets 6 are arranged at intervals in the X-axis direction. One oil pocket 6 is arranged in the Z-axis direction. In the Z-axis direction, the center of the oil pocket 6 and the center of the base member 8 coincide with each other. In the ZX plane, the oil pocket 6 has a square shape. The plurality of oil pockets 6 have equal shapes and dimensions.

The first region 51 is arranged so as to surround each of the plurality of the oil pockets 6. The first region 51 has a square outer shape. The outer shapes and dimensions of the plurality of the first regions 51 are equal to each other.

The second regions 52 are arranged at intervals in the X-axis direction. One second region 52 is arranged in the Z-axis direction. The first region 51 and the second region 52 are arranged in the X-axis direction. The first region 51 and the second region 52 are alternately arranged in the X-axis direction. The second region 52 is arranged between the first regions 51 adjacent to each other in the X-axis direction. The second region 52 has a rectangular outer shape elongated in the X-axis direction. The outer shapes and dimensions of the plurality of the second regions 52 are equal to each other.

In the X-axis direction, a dimension of the outer shape of the second region 52 is larger than a dimension of the outer shape of first region 51. In the Z-axis direction, a dimension of the outer shape of each first region 51 is equal to a dimension of the outer shape of each second region 52.

The groove 11 is provided between the first region 51 and each second region 52. Each of the grooves 11 extends in the Z-axis direction. The groove 11 is connected to the peripheral edges of the sliding surface 5. The groove 11 has an end on the +Z side that is connected to the peripheral edge on the +Z side of the sliding surface 5. The groove 11 has an end on the −Z side that is connected to the peripheral edge on the −Z side of the sliding surface 5. The groove 11 is open to atmosphere.

The groove 11 reduces the static pressure acting on the second region 52. The groove 11 also reduces the dynamic pressure acting on the sliding surface 5.

As described above, in the present embodiment as well, friction between the guide surface 4 of the support 2 and the sliding surface 5 of the movable body 3D is reduced. In addition, a decrease in the reliability of the guide device 1 is suppressed.

### Fifth Embodiment

A fifth embodiment will be described. In the following description, component elements the same as or equivalent to those in the above embodiment are denoted by the same reference numerals and symbols, and description thereof will be simplified or omitted.

FIG. 10 is a cross-sectional view schematically illustrating the guide device 1 according to the present embodiment. In the embodiments described above, the groove 11 that reduces the static pressure acting on the second region 52 is provided in the lower surface 80 of the base member 8. As illustrated in FIG. 10, grooves 11E may be provided in the guide surface 4 of a support 2E. In FIG. 10, a movable body 3E is guided to move in the X-axis directions relative to the support 2E. The first region 51 and the second regions 52 are arranged in the Z-axis direction. Each of the grooves 11E provided in the guide surface 4 is arranged so as to face a boundary between the first region 51 and the second region 52. The groove 11E extends in the X-axis direction.

In the present embodiment as well, the static pressure acting on the second region 52 is reduced. In the present embodiment as well, the friction between the guide surface 4 of the support 2 and the sliding surface 5 of the movable body 3B is reduced. In addition, a decrease in the reliability of the guide device 1 is suppressed.

### Other Embodiments

In the embodiments described above, the first film 9 is formed of the sliding material for coating, and the second film 10 is formed of the adhesive sliding material. The first film 9 may be formed of the adhesive sliding material. In other words, the first film 9 may be formed by bonding a sheet material of the first material to the annular area 81 with an adhesive. Furthermore, the second film 10 may be formed of the sliding material for coating. In other words, the second film 10 may be formed by curing the second material being liquid that has been applied to the outer area 82. Furthermore, when at least one of the first film 9 and the second film 10 is the sheet material, the sheet material may be fixed to the base member 8 by a fastening member such as a screw.

In the embodiments described above, the first material forming the first film 9 is the synthetic resin material containing an epoxy resin as the main component, and the second material forming the second film 10 is the synthetic resin material containing polytetrafluoroethylene as the main component. The first material and the second material are not limited to the synthetic resin materials described in the above embodiments. For example, the first film 9 may be a synthetic resin material containing polytetrafluoroethylene and a third material, and the second film 10 may be a synthetic resin material containing polytetrafluoroethylene and a fourth material.

In the embodiments described above, the coefficient of friction of the second region 52 to the guide surface 4 is lower than the coefficient of friction of the first region 51 to the guide surface 4. The coefficient of friction of the second region 52 to the guide surface 4 may be higher than the coefficient of friction of the first region 51 to the guide surface 4.

The coefficient of friction of the first region 51 to the guide surface 4 and the coefficient of friction of the second region 52 to the guide surface 4 may be equal.

In the embodiments described above, the area of the second region 52 is larger than the area of the first region 51. The area of the second region 52 may be smaller than the area of the first region 51. The area of the first region 51 and the area of the second region 52 may be equal.

In the embodiments described above, the groove 11 may not be connected to the peripheral edges of the sliding surface 5. Even if the groove 11 is not connected to the peripheral edges of the sliding surface 5, the static pressure acting on the second region 52 is lower than the static pressure acting on the first region 51.

In the embodiments described above, the groove 11 may be omitted. The distance between the oil pocket 6 and the second region 52 is larger than the distance between the oil pocket 6 and the first region 51. Therefore, even if the groove 11 is not provided, the static pressure acting on the second region 52 is lower than the static pressure acting on the first region 51.

In the embodiments described above, the second region 52 is arranged partially around the first region 51. The second region 52 may be arranged entirely around the first region 51. In other words, the second region 52 may be arranged so as to surround the first region 51.

In the embodiments described above, the guide device 1 is used as the guide device 1A. The guide device 1 may be used as the guide device 1B. When the guide device 1 is used as the guide device 1B, the guide device 1 is arranged between the bed 101 and the table 106 and guides the table 106 in the Z-axis direction.

In the embodiments described above, the machine tool 100 is the machining center, but is not limited thereto, and may be, for example, a laser processing machine, electron beam processing machine, honing machine, or a grinding machine. When the machine tool includes the first member and the second member that moves relative to the first member, the guide device 1 described in the above embodiments may be arranged between the first member and the second member.

### REFERENCE SIGNS LIST

1 GUIDE DEVICE
1A GUIDE DEVICE
1B GUIDE DEVICE
2 SUPPORT
2E SUPPORT
3 MOVABLE BODY
3B MOVABLE BODY
3C MOVABLE BODY
3D MOVABLE BODY
3E MOVABLE BODY
4 GUIDE SURFACE
5 SLIDING SURFACE
6 OIL POCKET
7 OIL PASSAGE
7A THROTTLE
7B SUPPLY PORT
8 BASE MEMBER
9 FIRST FILM
10 SECOND FILM
11 GROOVE
11E GROOVE
12 SHEET MATERIAL
13 GROOVE
51 FIRST REGION
52 SECOND REGION
61 CEILING SURFACE
62 PERIPHERAL WALL SURFACE
63 OPENING
80 LOWER SURFACE
81 ANNULAR AREA
82 OUTER AREA
100 MACHINE TOOL
101 BED
102 COLUMN
103 FIRST SUPPORT MEMBER
104 SECOND SUPPORT MEMBER
105 HEAD
106 TABLE
107 SUPPORT SURFACE
W WORK

1. A guide device comprising:
a support that includes a guide surface; and
a movable body that includes an oil pocket to which lubricant is supplied and a sliding surface facing the guide surface,
wherein the sliding surface includes:
a first region that is arranged around the oil pocket and formed of a first material; and
a second region that is arranged at least partially around the first region and formed of a second material.

2. The guide device according to claim 1, wherein
a static pressure acting on the second region is lower than a static pressure acting on the first region.

3. The guide device according to claim 1, wherein
the movable body includes:
a base member;
a first film that is formed of the first material applied to the base member; and
a second film that is a sheet material of the second material bonded to the base member,
the first region includes a lower surface of the first film, and
the second region includes a lower surface of the second film.

4. The guide device according to claim 1, wherein
the first material is a synthetic resin material containing an epoxy resin as a main component, and
the second material is a synthetic resin material containing polytetrafluoroethylene as a main component.

5. The guide device according to claim 1, wherein
a coefficient of friction of the second region to the guide surface is lower than a coefficient of friction of the first region to the guide surface.

6. The guide device according to claim 1, wherein
an area of the second region is larger than an area of the first region.

7. The guide device according to claim 1, further comprising
a groove that is provided between the first region and the second region.

8. The guide device according to claim 7, wherein
the groove is connected to a peripheral edge of the sliding surface.

9. The guide device according to claim 1, wherein
the movable body is guided to move in a first direction relative to the support, and
the first region and the second region are arranged in a second direction orthogonal to the first direction.

10. The guide device according to claim 1, wherein
the movable body is guided to move in a first direction relative to the support, and
the first region and the second region are arranged in the first direction.
